(19) United States
(12) Patent Application Publication
(10) Pub. No.: US 2026/0168646 A1
(43) Pub. Date: Jun. 18, 2026

(54) Lampshade with lattice structure

(71) Applicant: BEGA Gantenbrink-Leuchten KG, Menden (DE)

(72) Inventors: Jan Zellerhoff, Dortmund (DE); Jannik Götz, Schwelm (DE)

(73) Assignee: BEGA Gantenbrink-Leuchten KG, Menden (DE)

(21) Appl. No.: 19/420,134

(22) Filed: Dec. 15, 2025

(30) Foreign Application Priority Data
Dec. 17, 2024 (LU) LU103490

(51) Int. Cl. F21V 1/12

(52) U.S. Cl. CPC F21V 1/12

(57) ABSTRACT

A lampshade consists of a lattice structure. The lattice structure is formed of a plurality of lattice elements (3). Each lattice element (3) has a central axis (7) that extends through a centre of gravity (5) of the lattice element (3), perpendicularly to an envelope (6) of the lattice structure. The central axes (7) of the lattice elements are oriented in such a way that they each extend along a preferred viewing direction (8) through the respective lattice element (3), such that cavities (9) enclosed by the lattice elements (3) allow light through along the preferred viewing direction (8) and appear opaque from significantly deviating viewing directions.

### CROSS-REFERENCE TO RELATED APPLICATION

This application claims the benefit of Luxembourg Patent Application LU103490, filed on Dec. 17, 2024, the contents of which is incorporated by reference in its entirety.

### BACKGROUND

Lampshades are known from the prior art which are produced from lattice structures or perforated materials. Such lampshades are often used to generate interesting light and shadow effects, but are generally constructed isotropically, i.e. the arrangement of the lattice elements takes place without a preferred viewing direction. This leads to light being allowed through uniformly in all directions, without targeted control of the optical properties. Some known approaches attempt to achieve different degrees of translucency by variations in the shape, the size or the spacing of the lattice elements. These variations are typically achieved by adjustments of the geometry or the material thickness. Thinner or smaller lattice elements can allow more light through, while thicker or larger elements reduce the translucency. However, these techniques do not allow for targeted control of the opaqueness or translucency depending on a preferred viewing direction. Furthermore, conventional solutions lack the option of generating abrupt transitions between transparent and opaque appearance, which is disadvantageous in particular for applications with a greater aesthetic or functional requirement.

### SUMMARY

The present invention relates to a lampshade consisting of a lattice structure, wherein the lattice structure is formed of a plurality of lattice elements, wherein each lattice element has a central axis that extends through a centre of gravity of the lattice element, perpendicularly to an envelope of the lattice structure.

An improved lampshade is achieved in that the central axes of the lattice elements are oriented in such a way that they each extend along a preferred viewing direction through the respective lattice element, such that cavities enclosed by the lattice elements allow light through along the preferred viewing direction and appear opaque from significantly deviating viewing directions. This configuration allows for targeted control of the translucency and opaqueness, which supports both functional and aesthetic applications in lighting systems.

A clearance in a cross-sectional area of each lattice element in parallel with the envelope is maximally twice as large as a depth of the lattice element perpendicularly to the envelope in the region of the lattice element. The smaller cavities encompassed by the lattice elements are configured in relation to the depth of the lattice elements, the more restricted the view is through the lattice elements, deviating from the preferred viewing direction.

The lattice structure can be configured in the form of a conical or hyperboloidal body. A conical body has a base of larger diameter and tapers uniformly in the direction of an apex. In the case of a lampshade, the conical shape allows for targeted light guidance, since light beams from a central light source are scattered outwards along the conical surface. Advantageously, in this case, a uniform light distribution over the surroundings results, in particular if the lattice elements are arranged along the lateral surface of the cone in such a way that they allow light through along the preferred viewing direction. At the same time, the opaqueness from deviating directions is retained, since the cavities of the lattice elements act in an optically blocking manner in these viewing directions.

In contrast, a hyberboloid shape is characterised by a curved, elegant geometry, which is created by two opposing curvatures. Such a structure can be represented as a body of rotation, in which the lateral surface consists of asymptotic lines, which appear, optically, as intertwined lattice elements. This geometric shape is particularly aesthetically appealing, since it appears both dynamic and stable.

Advantageously, hyperboloid lattice structures can allow for a uniform light guidance along the curved surface. In this case, the light beams are not only scattered outwards, but rather can also be focussed or guided in particular directions, by the curvature of the structure. At the same time, the crossed lattice elements, which are oriented along the preferred viewing direction, create virtually complete opaqueness from deviating viewing angles, which makes the structure both functionally and optically notable.

These two shapes offer various advantages for the shaping and function of a lampshade. While the conical body offers a conventional and functional shape for the uniform lighting, the hyperboloid structure can serve as a modern and striking design approach. The selection of the shape can be made depending on the application and aesthetic requirements. For example, a conical lampshade could be used in functional work environment, while a hyperboloid lampshade is used in representative or decorative environments. Both shapes can be produced efficiently by additive production methods, as a result of which the precise orientation of the lattice elements is ensured.

The lattice structure is produced from an optically opaque material. This is advantageously achieved in that the translucency is controlled exclusively by the cavities of the lattice elements. Examples for suitable materials are optically opaque plastics materials, metals or ceramics, which offer high strength and durability and are suitable for various production techniques.

The cavities of the lattice structure can be shaped in such a way that the transition from translucency to opaqueness takes place abruptly in the case of a change of the viewing angle. Advantageously, a clear optical effect is achieved thereby, which is aesthetically appealing in particular for applications in architecture or in product design. For example, cavities can be configured having sharp edges or specific opening angles, in order to amplify this effect.

The cavities of the lattice structure can be shaped and oriented in such a way that they allow light through in a targeted manner along a preferred viewing direction, while the light is blocked in the case of significantly deviating viewing directions. This is achieved by the precise geometry of the cavities. For example, according to the invention trapezoidal or rectangular cavities can be used, in the case of which lattice walls of the cavity focus the light propagation onto a particular direction. Alternatively, elliptical or round cavities can be used, in order to allow for a softer light guidance.

The abrupt switch from translucency to opaqueness is achieved by the limiting of the light by the lattice walls of the cavities. These lattice walls are configured in such a way that they allow light through in a clearly defined direction, while it is shielded in other directions. The shape and depth of the cavities play a decisive role here: Deeper shaped cavities amplify the effect of the abrupt transition, since the light is focussed more strongly and the blocking in the case of deviating viewing angles is more complete. In contrast, flatter cavities offer a softer gradation of the transition, which may be advantageous for applications with a less pronounced visual barrier.

This shaping advantageously allows for a clear optical effect, which is aesthetically appealing in particular for applications in architecture or in product design. Rectangular and trapezoidal cavities can create clear light edges and shadowing, while elliptical or round cavities offer rather soft light progressions. This variability allows for adjustment of the optical properties of the lampshade to different functional and aesthetic requirements. For example, a lampshade comprising rectangular cavities could be used in a modern architectural environment, while elliptical cavities could be preferred for decorative lighting applications.

This abrupt change from translucency to opaqueness is not only an aesthetic feature, but rather also offers functional advantages. It can be used in visual barrier devices, light guidance systems or optical filters, in which precise control of the translucency is required. The exact shaping of the cavities and their orientation along the preferred viewing direction allow a versatile adjustment to the light and shadow properties of the lampshade.

Advantageously, the lattice structure can be provided with a light-reflecting or optically opaque coating, in order to allow for targeted light guidance. Examples for this are metallised or ceramic coatings, which achieve an improved light yield or make the lampshade usable as a reflector.

The lattice elements can be configured elliptically or polygonally along the preferred viewing direction, in order to amplify the desired translucency. The shape of the lattice elements plays a decisive role for the light guidance and the optical effect of the lattice structure. In particular, the geometry of the lattice elements influences how the light is conducted through the cavities of the lattice structure, in the preferred viewing direction.

Elliptical lattice elements are characterised by their curved, symmetrical shape, which allows for uniform light guidance. The gentle curvature of the elliptical contours results in the light being scattered uniformly, which leads to a soft light distribution along the preferred viewing direction. This property makes elliptical lattice elements particularly suitable for applications in which a pleasant, glare-free light is desired, for example in living rooms, restaurants or decorative lighting systems. The elliptical shape can furthermore achieve a harmonious overall image due to its soft transitions, which overall image fits seamlessly into modern and classic design concepts.

In contrast, polygonal lattice elements, e.g. having a triangular, rectangular or polygonal section, generate sharper optical effects. The straight edges and acute angles of these shapes guide the light in defined directions and generate precise light edges or shadowing. This property makes polygonal lattice elements particularly advantageous for technical applications, such as directed lighting or effect lighting in architectural installations. Furthermore, complex polygonal shapes, such as hexagonal or octagonal elements, can be used, in order to generate unique light patterns which are aesthetically appealing and make the lampshade a central design element.

Advantageously, the selection between elliptical and polygonal shapes can be matched to the specific requirements of the lighting application. For example, elliptical lattice elements could be used in a lampshade for the basic illumination of a room, in order to generate a uniform and pleasant light, while polygonal lattice elements could be used in accent lighting or as part of decorative luminaires, in order to create a dynamic play of light and shadow.

The shape of the lattice elements can furthermore be supplemented by their size, depth and arrangement, in order to amplify the optical effect. For example, elliptical lattice elements could be used in a deeper design, in order to focus the light more, while flat polygonal lattice elements allow for wider light scattering. This variability offers significant flexibility in the design of the lampshade and makes it possible to combine different requirements within a single lattice structure.

In addition, elliptical and polygonal lattice elements can be combined in one lampshade, in order to create both soft light progressions and sharp light edges. For example, elliptical lattice elements in the upper region of a lampshade could ensure a soft light distribution, while polygonal lattice elements in the lower region are used for targeted light guidance or decorative effects. This combination of different shapes significantly broadens the variety of applications of the invention.

The use of modern production methods, such as 3D printing or precision milling, makes it possible for elliptical and polygonal shapes to be produced with a high degree of accuracy. This ensures not only the optical quality of the lattice structure, but rather also its mechanical stability and durability.

The lattice elements of the lattice structure can be configured to be of different sizes and/or can have different shapings. The size and shape of the lattice elements directly influence the translucency and opaqueness of the lattice structure and allow for a versatile possibility of adjusting the optical properties of the lampshade in a targeted manner. The variations can take place both systematically and irregularly along the surface of the lampshade, in order to fulfil specific lighting or design requirements.

Advantageously, larger lattice elements can achieve an increased translucency, since the cavities between the lattice elements are larger and allow more light through. Such larger lattice elements can be arranged in regions of the lampshade in which a greater light output is desired, for example for illuminating particular spatial regions or for creating lighting accents. Vice versa, smaller lattice elements can be used to achieve greater opaqueness, since the smaller cavities allow less light through and have an optically closed effect. This property is useful in particular in regions which require a visual barrier or targeted light blocking.

The shaping of the lattice elements offers a further level of adjustment options. Round or elliptical lattice elements create soft light progressions and are particularly suitable for applications in which a uniform light distribution is desired. Angular lattice elements, such as rectangular or polygonal shapes, may create sharper shadowing or clearly delimited light zones, which is advantageous in decorative or technical applications. Furthermore, more complex geometries, such as curved or asymmetrical shapes, can create unique aesthetic effects, which make the lampshade a visual highlight.

Advantageously, the variations in size and shape of the lattice elements can also be used in combination, in order to fulfil specific optical or functional requirements. For example, larger, round lattice elements could be arranged in the top half of a lampshade, in order to ensure a soft and wide light distribution, while smaller, angular lattice elements in the lower half ensure targeted light guidance or opaqueness. Such combinations allow for the lampshade to be optimised both functionally and aesthetically.

The implementation of these variations can be achieved efficiently by modern production methods, such as 3D printing or precise mechanical methods. These techniques make it possible to produce lattice elements of individually adjusted sizes and shapes within a single lattice structure, without additional assembly steps. This not only increases the design flexibility, but rather also ensures the structural integrity of the lampshade.

The material thickness of a lattice wall of the lattice elements, which forms the lattice element, can be different, such that spacings between the cavities of the lattice elements are varied. In this case, the lattice wall that defines the lattice element is the boundary structure which specifies the shape and the dimensions of the lattice element. The spacing between neighbouring cavities can be adjusted by targeted variation of the material thickness of these lattice walls, without changing the essential geometry of the lattice elements themselves. This allows for precise control of the translucency and opaqueness along the surface of the lampshade.

Advantageously, thicker lattice walls can increase the spacing between the cavities, as a result of which the translucency in this region is reduced, since tie wider lattice walls block more surface area. In regions in which a high degree of translucency is desired, the lattice walls can be configured to be thinner, as a result of which the cavities move closer together and more light is allowed through. This adjustment of the material thickness offers an additional design level, which can be achieved irrespective of the shape or size of the lattice elements.

For example, a lampshade could be produced having thinner lattice walls in the upper region, in order to achieve greater translucency there, while thicker lattice walls are used in the lower region of the lampshade, in order to achieve greater opaqueness or a more targeted light guidance. This variation in the material thickness can be distributed continuously or in portions over the lattice structure, as a result of which both soft transitions and sharply delimited optical zones can occur.

The material thickness of the lattice wall affects not only the optical properties, but rather also the mechanical stability of the lattice structure. Targeted reinforcements in regions with higher loading makes it possible to improve the structural integrity of the lampshade, without impairing the desired optical effect. Such variations in the material thickness can advantageously be achieved efficiently and precisely by modern production methods, in particular additive methods such as 3D printing.

Advantageously, the lattice walls of the lattice elements can have a round or angular cross-section. A round cross-section offers soft light refraction and is suitable in particular for applications in which a uniform light emission is desired. In contrast, an angular cross-section, for example square or rectangular, can create sharper optical edges and shadowing, which is advantageous in the case of decorative or technically demanding applications. The selection of the cross-section can be made according to the desired light guidance and the aesthetic design. Both cross-sectional shapes can be precisely implemented by additive production methods or mechanical methods.

The lattice structure can be produced in one piece. This advantageously achieves a high degree of stability and a seamless design, which improves both the functionality and the aesthetics of the lampshade.

The lattice structure can advantageously be produced by an additive production method. Examples for this are 3D printing methods, which allow for precise and economical production of complex structures. In particular, lattice structures with varying geometries and material thicknesses can be manufactured in a single production step by additive methods.

Further advantageous embodiments are explained in more detail with reference to an embodiment that is shown in the drawings.

### BRIEF DESCRIPTION OF THE DRAWINGS

FIG. 1 is a schematic view of a lampshade, and

FIG. 2 is a detail of the lampshade shown in FIG. 1.

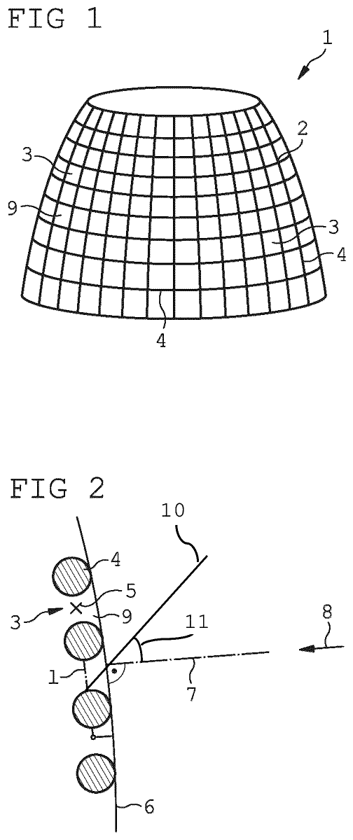

### DETAILED DESCRIPTION

A lampshade 1 is shown schematically in the figures. The lampshade 1 consists of a lattice structure 2 that is formed of a plurality of lattice elements 3. Each lattice element 3 is delimited by lattice walls 4.

Each lattice element 3 has a central axis 7 that extends through a centre of gravity 5 of the lattice element 3, perpendicularly to an envelope 6 of the lattice structure 2, which central axes are in each case oriented in such a way that they extend along a preferred viewing direction 8, through the respective lattice element 3. In this way, the cavities 9 enclosed by the lattice elements 3 allow light through along the preferred viewing direction 8 and appear opaque from significantly deviating viewing directions.

The lattice walls 4 are configured in such a way that a clearance l in a cross-sectional area of each lattice element 3 in parallel with the envelope 6 is maximally twice as large as a depth d of the lattice element 3 perpendicularly to the envelope 6 in the region of the lattice element 3.

As used herein, a “significantly deviating viewing direction” refers to a viewing direction 10 that is inclined relative to a preferred viewing direction 8 by a deviation angle β, 11, where the deviation angle β, 11 is defined as the angle between direction vectors corresponding to the viewing directions 8 and 10, for example as determined in a region of a centroid 5 of a respective lattice element 3. A viewing direction is considered highly deviating when the deviation angle β, 11 is at least 30°, preferably at least 45°, and more preferably at least 60°. Within this angular range, a line of sight through the respective lattice element 3 is laterally offset relative to a central axis 7 or the preferred viewing direction 8 such that wall portions formed by lattice walls 4 predominantly obstruct the line of sight, thereby causing cavities 9 to appear opaque when viewed from the viewing direction 10.

In the figures, individual elements of a plurality of identical elements are denoted by a reference sign, by way of example.

What is claimed is:

1. A lampshade (1), comprising:
a lattice structure (2),
wherein the lattice structure (2) is formed of a plurality of lattice elements (3),
wherein each lattice element (3) has a central axis (7) that extends through a centre of gravity (5) of the lattice element (3), perpendicularly to an envelope (6) of the lattice structure (2),
wherein the central axes (7) of the lattice elements are oriented such that they each extend along a preferred viewing direction (8) through the respective lattice element (3), such that cavities (9) enclosed by the lattice elements (3) allow light through along the preferred viewing direction (8) and appear opaque from significantly deviating viewing directions.

2. The lampshade (1) according to claim 1,
wherein a clearance (l) in a cross-sectional area of each lattice element (3) in parallel with the envelope (6) is maximally twice as large as a depth d of the lattice element (3) perpendicularly to the envelope (6) in a region of the lattice element (3).

3. The lampshade (1) according to claim 1,
wherein the lattice structure (2) is configured in the form of a conical or hyperboloidal body.

4. The lampshade (1) according to claim 1,
wherein the lattice structure (2) is produced from an optically opaque material.

5. The lampshade (1) according to claim 1,
wherein the cavities (9) of the lattice structure (2) are shaped in such a way that a transition from translucency to opaqueness takes place abruptly in the case of a change of the viewing angle.

6. The lampshade (1) according to claim 1,
wherein the lattice structure (2) is provided with a light-reflecting or optically opaque coating, in order to allow for targeted light guidance.

7. The lampshade (1) according to claim 1,
wherein the lattice elements (3) are configured elliptically or polygonally along the preferred viewing direction (8).

8. The lampshade (1) according to claim 1,
wherein the lattice elements (3) of the lattice structure (2) are configured to be of different sizes and/or have different shapings.

9. The lampshade (1) according to claim 1,
wherein a material thickness of a lattice wall (4) of the lattice elements (3) that forms the lattice element is different, such that spacings between the cavities (8) of the lattice elements (3) are varied.

10. The lampshade (1) according to claim 1,
wherein lattice walls (4) of the lattice elements (3) have a round or angular cross-section.

11. The lampshade (1) according to claim 1,
wherein the lattice structure (2) is produced in one piece.

12. The lampshade according to claim 11,
wherein the lattice structure is produced by an additive production method.
